(19) United States
(12) Patent Application Publication
(10) Pub. No.: US 2015/0055213 A1
(43) Pub. Date: Feb. 26, 2015

(54) METAL OXIDE MULTI-LAYERED STRUCTURE FOR INFRARED BLOCKING

(71) Applicant: Industrial Technology Research Institute, Hsinchu (TW)

(72) Inventors: Pei-Hsin Yang, Yunlin County (TW); Yu-Chun Chen, Taoyuan County (TW); Yi-Chen Chen, Kaohsiung City (TW); Chin-Ching Lin, Taichung City (TW); Mei-Ching Chiang, Hsinchu County (TW); Hung-Chou Liao, Taoyuan County (TW)

(73) Assignee: Industrial Technology Research Institute, Hsinchu (TW)

(21) Appl. No.: 14/080,799

(22) Filed: Nov. 15, 2013

(30) Foreign Application Priority Data
Aug. 22, 2013 (TW) 102130002

(51) Int. Cl. G02B 5/20

(52) U.S. Cl. CPC G02B 5/206; G02B 5/208
USPC 359/360

(57) ABSTRACT

Provided is a metal oxide multi-layered structure for infrared blocking, which includes a first metal oxide film, a second metal oxide film, a third metal oxide film, and a metal nanoparticle layer. The third metal oxide film is disposed between the first metal oxide film and the second metal oxide film. The metal nanoparticle layer is disposed between the second metal oxide film and the third metal oxide film.

### CROSS-REFERENCE TO RELATED APPLICATION

This application claims the priority benefit of Taiwan application serial no. 102130002, filed on Aug. 22, 2013. The entirety of the above-mentioned patent application is hereby incorporated by reference herein and made a part of this specification.

### TECHNICAL FIELD

This disclosure generally relates to a metal oxide multi-layered structure for infrared blocking.

### BACKGROUND

Extreme climate changes all over the world, such as extremely cold winters or extremely warm summers that occur more frequently than ever, due to the effect of global warming, have urged people to pay more attention to the development of renewable energy and energy-saving technology. In addition to the use of environment-friendly construction materials and renewable energy, architects are endeavoring to apply more high-tech energy-saving building materials and green building space design, so that people can more easily live in the harsh environment. Energy-saving glass is one of the most widely used high-tech building materials, which can be used to block the heat of sunlight from entering the house and prevent the indoor temperature from rising. With use of energy-saving glass, indoor lighting can be maintained and use of air conditioning can be reduced, and thus the energy saving effect can be achieved.

Generally, glass plated with a silver layer is used to block infrared ray from entering indoor. The plated glass is manufactured by performing a vacuum sputtering method to form multiple layers of different materials on the glass surface. Since the silver layer is not heat-resistant and can be oxidized when exposed to the air, an anti-reflective layer is usually formed under the silver layer and a metal barrier layer is usually formed above the silver layer, and an anti-reflective layer is then formed on top of the metal barrier layer to protect the overall layers. For double-silver-layer glass or triple-silver-layer glass that is common in the market, more multi-layered stacks are needed so as to achieve infrared blocking and heat insulation.

### SUMMARY

This disclosure provides a metal oxide multi-layered structure for infrared blocking, which includes a first metal oxide film, a second metal oxide film, a third metal oxide film, and a metal nanoparticle layer. The third metal oxide film is disposed between the first metal oxide film and the second metal oxide film. The metal nanoparticle layer is disposed between the second metal oxide film and the third metal oxide film.

Specific embodiments are given below to illustrate how to embody the disclosure, so that persons skilled in the art can better understand the disclosure through the specification. The disclosure may also be implemented or applied through other different embodiments. Thus, modifications and/or alterations can be made to details of the disclosure according to different viewpoints and applications without departing from the spirit of the disclosure.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view of a metal oxide multi-layered structure for infrared blocking according to the first embodiment of the disclosure.

FIG. 2 is a schematic cross-sectional view of a metal oxide multi-layered structure for infrared blocking according to the second embodiment of the disclosure.

FIG. 3 is a diagram illustrating a relationship between the thickness of a first metal oxide film (LFTO) and an infrared blocking rate, obtained from a simulated experimental example of the disclosure.

### DETAILED DESCRIPTION OF DISCLOSED EMBODIMENTS

FIG. 1 is a schematic cross-sectional view of a metal oxide multi-layered structure for infrared blocking according to the first embodiment of the disclosure.

With reference to FIG. 1, a metal oxide multi-layered structure 100A for infrared blocking in the first embodiment of the disclosure includes a substrate 50, a first metal oxide film 10, a second metal oxide film 20, a third metal oxide film 30, and a metal nanoparticle layer 40.

The substrate 50 is a glass substrate, a transparent resin substrate, or a combination of the foregoing, for example.

The first metal oxide film 10 is disposed above the substrate 50 and covers the third metal oxide film 30. A refractive index of the first metal oxide film 10 is 1.8≦n≦2, and the thickness of the first metal oxide film 10 is 100 nm to 550 nm, for example. The first metal oxide film 10 includes tin oxide, fluorine-doped tin oxide (FTO), lithium-fluorine doped tin oxide (LFTO), or a combination of the foregoing. According to one embodiment, in an experimental example where the first metal oxide film 10 is a fluorine-doped tin oxide, a doping amount of fluorine ions is not more than 5% (atoms percent) and free of indium ions. According to another embodiment, in an experimental example where the first metal oxide film 10 is a lithium-fluorine doped tin oxide, the doping amount of fluorine ions is not more than 5% (atoms percent), a doping amount of lithium ions is not more than 5% (atoms percent), and free of indium ions. A forming method of the first metal oxide film 10 may include a variety of wet coating methods, such as spin coating, die coating, blade coating, roller coating, or dip coating, etc. The first metal oxide film 10 can also be formed using a deposition method, such as chemical vapor deposition (CVD) or physical vapor deposition (PVD). The physical vapor deposition method includes sputtering or spraying, etc., for example. Details of the forming method of the first metal oxide film 10 can be obtained by referring to Taiwanese Patent No. 1367530, the entirety of which is incorporated by reference herein, or the first metal oxide film 10 may be prepared using methods similar to those described in the aforementioned Patent.

The second metal oxide film 20 is disposed between the substrate 50 and the first metal oxide film 10. More specifically, a surface 20a of the second metal oxide film 20 is in contact with the substrate 50, and the other surface 20b of the second metal oxide film 20 is covered by the third metal oxide film 30 and a metal nanoparticle layer 40. The second metal oxide film 20 has material properties different from the first metal oxide film 10. For example, a refractive index of the second metal oxide film 20 is 2≦n≦2.3, and the thickness of the second metal oxide film 20 is 30 nm to 200 nm, for example. A material of the second metal oxide film 20 includes titanium dioxide, tin oxide, zinc oxide, or a combination of the foregoing. A forming method of the second metal oxide film 20 may include a variety of wet coating methods, such as spin coating, die coating, blade coating, roller coating, or dip coating, etc. The second metal oxide film 20 can also be fowled using a deposition method, such as CVD or PVD. The physical vapor deposition method includes sputtering or spraying, etc., for example.

The third metal oxide film 30 is disposed between the first metal oxide film 10 and the second metal oxide film 20, and covers the metal nanoparticle layer 40. More specifically, the third metal oxide film 30 covers the metal nanoparticle layer 40 and covers the surface 20b of the second metal oxide film 20 exposed by a gap in the metal nanoparticle layer 40. The third metal oxide film 30 has material properties different from the first metal oxide film 10. The third metal oxide film 30 may have material properties that are the same as or different from the second metal oxide film 20. A refractive index of the third metal oxide film 30 is 2≦n≦2.3, and the thickness of the third metal oxide film 30 is 30 nm to 200 nm, for example. A material of the third metal oxide film 30 includes titanium dioxide, tin oxide, zinc oxide, or a combination of the foregoing. A forming method of the third metal oxide film 30 may include a variety of wet coating methods, such as spin coating, die coating, blade coating, roller coating, or dip coating, etc. The third metal oxide film 30 can also be formed using a deposition method, such as CVD or PVD. The physical vapor deposition method includes sputtering or spraying, etc., for example.

The metal nanoparticle layer 40 is disposed between the second metal oxide film 20 and the third metal oxide film 30. More specifically, the metal nanoparticle layer 40 is disposed on the surface 20b of the second metal oxide film 20 and is covered by the third metal oxide film 30. Metal nanoparticles of the metal nanoparticle layer 40 may be arranged in an order, such as in an array or in multiple arrays, but the disclosure is not limited thereto. Otherwise, the metal nanoparticle layer 40 can be in a random arrangement. A material of the metal nanoparticle layer 40 includes silver, gold, or an alloy thereof. A particle size of the metal nanoparticles is 80 nm to 150 nm, and an average pitch P1 of the metal nanoparticles is 90 nm to 250 nm. A forming method of the metal nanoparticle layer 40 may include a variety of wet coating methods, such as spin coating, blade coating, roller coating, or dip coating, etc. A deposition method, such as CVD or PVD, can also be used. The physical vapor deposition method includes sputtering or spraying, etc., for example.

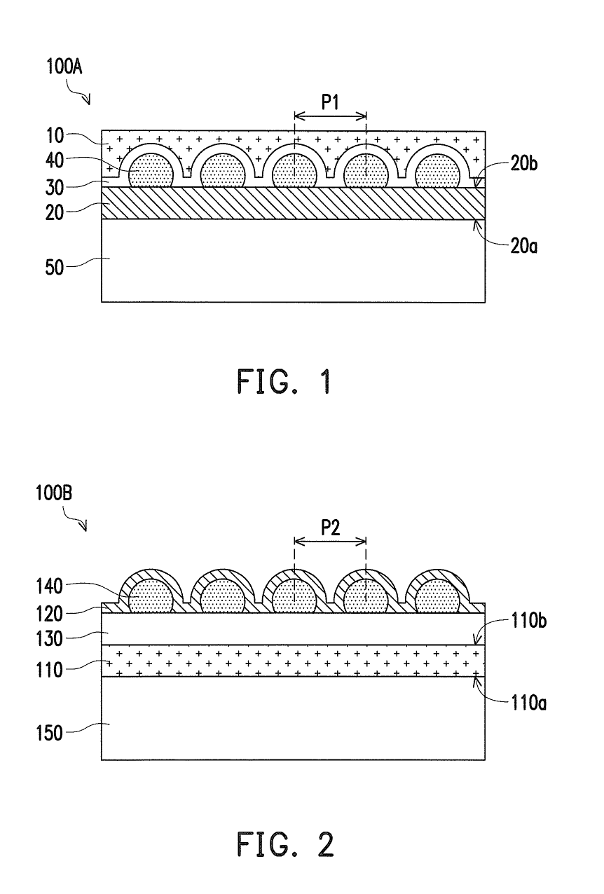

FIG. 2 is a schematic cross-sectional view of a metal oxide multi-layered structure for infrared blocking according to the second embodiment of the disclosure.

With reference to FIG. 2, a metal oxide multi-layered structure 100B for infrared blocking in the second embodiment of the disclosure includes a substrate 150, a first metal oxide film 110, a second metal oxide film 120, a third metal oxide film 130, and a metal nanoparticle layer 140.

The substrate 150 is a glass substrate, a transparent resin substrate, or a combination of the foregoing, for example.

The first metal oxide film 110 is disposed on the substrate 150. A surface 110a of the first metal oxide film 110 is in contact with the substrate 150, and a surface 110b of the first metal oxide film 110 is in contact with the third metal oxide film 130. A refractive index of the first metal oxide film 110 is 1.8≦n≦2, and the thickness of the first metal oxide film 110 is 100 nm to 550 nm, for example. A material of the first metal oxide film 110 includes tin oxide, fluorine-doped tin oxide (FTO), lithium-fluorine doped tin oxide (LFTO), or a combination of the foregoing. In one embodiment where the first metal oxide film 110 is a fluorine-doped tin oxide, a doping amount of fluorine ions is not more than 5% (atoms percent) and free of indium ions. In one embodiment where the first metal oxide film 110 is a lithium-fluorine doped tin oxide, the doping amount of fluorine ions is not more than 5% (atoms percent), a doping amount of lithium ions is not more than 5% (atoms percent), and free of indium ions. A forming method of the first metal oxide film 110 may include a variety of wet coating methods, such as spin coating, die coating, blade coating, roller coating, or dip coating, etc. The first metal oxide film 110 can also be formed using a deposition method, such as CVD or PVD. The physical vapor deposition method includes sputtering or spraying, etc., for example. Details of the forming method of the first metal oxide film 110 can be obtained by referring to Taiwanese Patent No. I367530, the entirety of which is incorporated by reference herein, or the first metal oxide film 110 may be prepared using methods similar to those described in the aforementioned Patent.

The second metal oxide film 120 covers the metal nanoparticle layer 140 and covers a surface of the third metal oxide film 130 exposed by a gap in the metal nanoparticle layer 140. The second metal oxide film 120 has material properties different from the first metal oxide film 110. For example, a refractive index of the second metal oxide film 120 is 2≦n≦2.3, and the thickness of the second metal oxide film 120 is 30 nm to 200 nm, for example. A material of the second metal oxide film 120 includes titanium dioxide, tin oxide, zinc oxide, or a combination of the foregoing. A forming method of the second metal oxide film 120 may include a variety of wet coating methods, such as spin coating, die coating, blade coating, roller coating, or dip coating, etc. The second metal oxide film 120 can also be formed using a deposition method, such as CVD or PVD. The physical vapor deposition method includes sputtering or spraying, etc., for example.

The third metal oxide film 130 is disposed between the second metal oxide film 120 and the first metal oxide film 110. More specifically, the third metal oxide film 130 is disposed on the surface 110b of the first metal oxide film 110, and a surface of the third metal oxide film 130 is covered by the metal nanoparticle layer 140 and the second metal oxide film 120. The third metal oxide film 130 has material properties different from the first metal oxide film 110. The third metal oxide film 130 may have material properties that are the same as or different from the second metal oxide film 120. A refractive index of the third metal oxide film 130 is 2≦n≦2.3, and the thickness of the third metal oxide film 130 is 30 nm to 200 nm, for example. A material of the third metal oxide film 130 includes titanium dioxide, tin oxide, zinc oxide, or a combination of the foregoing. A forming method of the third metal oxide film 130 may include a variety of wet coating methods, such as spin coating, die coating, blade coating, roller coating, or dip coating, etc. The third metal oxide film 130 can also be formed using a deposition method, such as CVD or PVD. The physical vapor deposition method includes sputtering or spraying, etc., for example.

The metal nanoparticle layer 140 is disposed between the second metal oxide film 120 and the third metal oxide film 130. Metal nanoparticles of the metal nanoparticle layer 140 may be arranged in an order, such as in an array or in multiple arrays, but the disclosure is not limited thereto. Otherwise, the metal nanoparticle layer 140 can be in a random arrangement. A material of the metal nanoparticle layer 140 includes silver. A particle size of the metal nanoparticles of the metal nanoparticle layer 140 is 80 nm to 150 nm, and an average pitch P2 of the metal nanoparticle layer 140 is 90 nm to 250 nm. A forming method of the metal nanoparticle layer 140 may methods, such as spin coating, blade coating, roller coating, or dip coating, etc. A deposition method, such as CVD or PVD, can also be used. The physical vapor deposition method includes sputtering or spraying, etc., for example.

Specific embodiments are given below to further explain characteristics and efficiency of the disclosure. However, it should be noted that the following is not intended to limit the disclosure.

### Experimental Examples 1 to 4

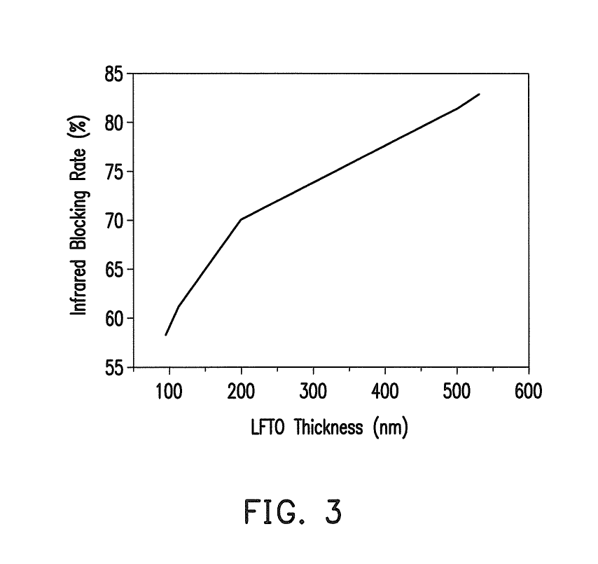

In Examples 1 to 4, a first metal oxide film, a second metal oxide film, a third metal oxide film, and a silver nanoparticle layer are formed on a glass substrate (coming glass) of 0.7 mm, with the materials and thicknesses specified in Table 1, so as to form the metal oxide multi-layered structure 100A (FIG. 1) of the first embodiment. Then, the formed structure is measured to obtain a visible light transmittance and an infrared blocking rate thereof. The results are shown in Table 2. The relationship between the thickness of the first metal oxide film (LFTO) and the infrared blocking rate is shown in FIG. 3.

### Experimental Examples 5 to 8

In Examples 5 to 8, a first metal oxide film, a second metal oxide film, a third metal oxide film, and a silver nano layer are formed on a glass substrate (coming glass) of 0.7 mm, with the materials and thicknesses specified in Table 3, so as to form the metal oxide multi-layered structure 100B (FIG. 2) of the second embodiment. Then, the metal oxide multi-layered structure for infrared blocking is measured to obtain a visible light transmittance and an infrared blocking rate thereof. The results are shown in Table 4.

In this disclosure, the particle size of the metal particles and the average pitch between the metal particles are analyzed using SEM micro-structured surface analysis and then calculated by microscopic image measurement system Image-Pro Plus software (Brand: Media Cybernetics).

### Comparative Example 1

The visible light transmittance and infrared blocking rate of the glass substrate (corning glass) of 0.7 mm are measured, and the results are shown in Table 2 and Table 4.

### Comparative Example 2

A method in accordance with Example 1, but without forming the first metal oxide. Then, the metal oxide multi-layered structure for infrared blocking is measured to obtain the visible light transmittance and the infrared blocking rate thereof. The results are shown in Table 2.

TABLE 1

| | Thickness | Thickness | Thickness | Particle | Average |
|---|---|---|---|---|---|
| | of the | of the | of the | size of | pitch of |
| | first met- | second met- | third met- | metal | metal |
| | al oxide | al oxide | al oxide | nanoparti- | nanoparti- |
| | film (nm) | film (nm) | film (nm) | cles (nm) | cles (nm) |
| Material | LFTO | TiO₂ | TiO₂ | Ag | |
| Example 1 | 200 | 30 | 30 | 90 | 106 |
| Example 2 | 200 | 30 | 30 | 130 | 210 |
| Example 3 | 95 | 30 | 30 | 90 | 106 |
| Example 4 | 530 | 30 | 30 | 90 | 106 |
| Compara- | | | | | |
| tive | | | | | |
| Example 1 | | | | | |
| Compara- | | 30 | 30 | 90 | 106 |
| tive | | | | | |
| Example 2 | | | | | |

TABLE 2

| | Visible light | Infrared |
|---|---|---|
| | transmittance (%) | blocking rate (%) |
| Example 1 | 58 | 69 |
| Example 2 | 55 | 61 |
| Example 3 | 59 | 58 |
| Example 4 | 56 | 83 |
| Comparative Example 1 | 92 | 0 |
| Comparative Example 2 | 54 | 46 |

TABLE 3

| | Thickness | Thickness | Thickness | Particle | Average |
|---|---|---|---|---|---|
| | of the | of the | of the | size of | pitch of |
| | first met- | second met- | third met- | metal | metal |
| | al oxide | al oxide | al oxide | nanoparti- | nanoparti- |
| | film (nm) | film (nm) | film (nm) | cles (nm) | cles (nm) |
| Material | LFTO | TiO₂ | TiO₂ | Ag | |
| Compara- | | | | | |
| tive | | | | | |
| Example 1 | | | | | |
| Example 5 | 200 | 30 | 30 | 90 | 106 |
| Example 6 | 112 | 30 | 30 | 90 | 106 |
| Example 7 | 498 | 30 | 30 | 90 | 106 |
| Example 8 | 200 | 30 | 175 | 90 | 106 |

TABLE 4

| | Visible light | Infrared |
|---|---|---|
| | transmittance (%) | blocking rate (%) |
| Comparative Example 1 | 92 | 0 |
| Example 5 | 51 | 70 |
| Example 6 | 58 | 61 |
| Example 7 | 53 | 81 |
| Example 8 | 52 | 69 |

According to the results shown in Table 2, Table 4, and FIG. 3, when the thickness of the layer of lithium-fluorine doped tin oxide (LFTO) is controlled at 105 nm or more, the metal oxide multi-layered structure for infrared blocking can block 60% of an infrared ray or more, and allow most visible light to pass through with an average visible light transmittance of 50%, which achieves the effects of lighting and heat insulation.

In conclusion of the above, the metal oxide multi-layered structure for infrared blocking according to the embodiments of the disclosure has fewer layers, which simplifies the fabrication process. In addition, silver nanoparticles are used to replace a silver film, which reduces production costs and increases the visible light transmittance. By controlling the particle size of the metal nanoparticles, the pitch, and the thickness of the metal oxide film lamination, 60% of infrared ray or more can be blocked while most visible light can be allowed to pass through with the average visible light transmittance of about 50%, so as to achieve the effects of lighting and heat insulation.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A metal oxide multi-layered structure for infrared blocking, comprising:
a first metal oxide film;
a second metal oxide film;
a third metal oxide film disposed between the first metal oxide film and the second metal oxide film; and
a metal nanoparticle layer disposed between the second metal oxide film and the third metal oxide film.

2. The metal oxide multi-layered structure according to claim 1, wherein a material of metal nanoparticles of the metal nanoparticle layer is silver nanoparticles.

3. The metal oxide multi-layered structure according to claim 1, wherein an average pitch between the metal nanoparticles is 90 nm to 250 nm.

4. The metal oxide multi-layered structure according to claim 1, wherein a particle size of the metal nanoparticles is 80 nm to 150 nm.

5. The metal oxide multi-layered structure according to claim 1, wherein a particle size of the metal nanoparticles is 80 nm to 150 nm, and an average pitch between the metal nanoparticles is 90 nm to 250 nm.

6. The metal oxide multi-layered structure according to claim 1, wherein a refractive index of the first metal oxide film is 1.8≦n≦2; a refractive index of the second metal oxide film is 2≦n≦2.3; and a refractive index of the third metal oxide film is 2≦n≦2.3.

7. The metal oxide multi-layered structure according to claim 6, wherein a thickness of the first metal oxide film is 100 nm to 550 nm; a thickness of the second metal oxide film is 30 nm to 200 nm; and a thickness of the third metal oxide film is 30 nm to 200 nm.

8. The metal oxide multi-layered structure according to claim 1, wherein a material of the first metal oxide film comprises tin oxide, fluorine-doped tin oxide (FTO), lithium-fluorine doped tin oxide (LFTO), or a combination of the foregoing.

9. The metal oxide multi-layered structure according to claim 1, wherein a material of the second metal oxide film comprises titanium dioxide, tin oxide, zinc oxide, or a combination of the foregoing.

10. The metal oxide multi-layered structure according to claim 1, wherein a material of the third metal oxide film comprises titanium dioxide, tin oxide, zinc oxide, or a combination of the foregoing.

11. The metal oxide multi-layered structure according to claim 1, further comprising a substrate, on which the metal oxide multi-layered structure is disposed.

12. The metal oxide multi-layered structure according to claim 11, wherein a first surface of the second metal oxide film is in contact with the substrate, and a second surface of the second metal oxide film is covered by the metal nanoparticle layer and the third metal oxide film, wherein the first surface and the second surface are at different sides of the second metal oxide film.

13. The metal oxide multi-layered structure according to claim 11, wherein a first surface of the first metal oxide film is in contact with the substrate, and a second surface of the first metal oxide film is in contact with the third metal oxide film.

14. The metal oxide multi-layered structure according to claim 11, wherein the substrate comprises a glass substrate, a transparent resin substrate, or a combination of the foregoing.
